(19) United States
(12) Patent Application Publication
(10) Pub. No.: US 2006/0095648 A1
(43) Pub. Date: May 4, 2006

(54) Method and apparatus for partitioning a memory

(75) Inventors: Chia-Shang Yuan, Taichung City (TW); Chih-Hao Hsin, Taipei City (TW)

Correspondence Address: SNELL & WILMER;ONE ARIZONA CENTER, 400 EAST VAN BUREN, PHOENIX, AZ, 850040001, US

(73) Assignee: BenQ Corporation

(21) Appl. No.: 11/267,233

(22) Filed: Nov. 3, 2005

(30) Foreign Application Priority Data
Nov. 3, 2004 (TW) 93133452

(51) Int. Cl. G06F 12/14

(52) U.S. Cl. 711/100

(57) ABSTRACT

A method and an apparatus for partitioning a memory of an electronic apparatus are provided. The memory is initially partitioned into a first zone and a second zone by an old boundary address, wherein the first zone stores data that users can input and the second zone stores a first code for operation of the electronic apparatus. The present invention downloads a second code to the electronic apparatus to overwrite the first code, computes a new boundary address according to the physical space amount occupied by the second code, and saves the new boundary address in the memory.

### CROSS-REFERENCE TO RELATED APPLICATIONS

This Application claims the right of priority based on Taiwan Patent Application No. 093133452 filed on Nov. 3, 2004.

### FIELD OF INVENTION

The present invention generally relates to a method and a system for determining the partition of a memory according to a size of a stored code.

### BACKGROUND OF THE INVENTION

Because of the diversified functions of the electronic apparatuses nowadays, the operation code of the electronic apparatus and the input data from users usually need to be stored in the memory. Due to the space limitation and the cost consideration, some wireless communication apparatuses (e.g., mobile phone, PDA etc.) have to partition a memory into two parts for separately storing the code and the data.

For example, most mobile phones store the code and the data by the NAND gate flash memories. As shown in FIG. 1, the NAND gate flash memory 1 in the mobile phone is partitioned into two zones: the first zone 11 and the second zone 13. The first zone 11 is configured to store the input data from users (also known as the file system), which includes a phone book, a calendar, an alarm timer, and a personalized ring tone of the mobile phone, etc. The second zone 13 is configured to store the code for performing various functions of the mobile phone.

The capacities of the first zone 11 and the second zone 13 are determined by the practical size of the code before the mobile phone leaves the factory. For example, if the capacity of the NAND gate flesh memory 1 is 32 MB and the required size for the code is 19.8 MB, then the size of the second zone may be set to be 20 MB, which leads to the size of the first zone 11 to be 12 MB. Accordingly, as the FIG. 1 shows, the practical configuration is that the second zone 13 starts at the address 0x0000000 and ends at the 0x1400000 with a total size of 20 MB, and the first zone 11 starts at the address 0x1400000 and ends at the 0x2000000 with a total size of 12 MB. According to the example in the FIG. 1, the address 0x1400000 becomes the boundary address of the first zone 11 and the second zone 13.

Some blocks of the NAND gate flash memory 1 may be defected and may not be used due to unknown factors after the mobile phone leaves the factory. FIG. 2 illustrates the influence of the defect conditions on data storage. As shown in FIG. 2, a data 21 is assumed to be stored in the first zone 11. The data 21 includes five blocks: block 1, block 2, block 3, block 4 and block 5. Since the data 21 cannot be stored successively in the blocks 211, 213, 215 217 and 219 of the first zone 11 due to the defects in some blocks (namely blocks 213, 217 and 223) of the first zone 11, the defect blocks 213, 217 and 223 have to be skipped while storing the block 1, block 2, block 3, block 4 and block 5 of the data 21 into the first zone 11.

The capacity of the second zone 13 is usually set to be close to and larger than the size of the code (for example, the second zone 13 is set to 20 MB for the code with size of 19.8 MB) for leaving a maximum space to store the input data from users. However, when the second zone 13 has many defect blocks (e.g., the actual usable space is smaller than 19.8 MB), parts of the code may be forced to cross the boundary address 0x1400000 and be stored in the first zone 11 due to the insufficient non-defect capacity of the second zone 13. With respect to the mobile phone, the data stored in a first zone 11 has a predetermined format, the code which is stored in the first zone 11 is unidentifiable by the system and therefore may be overwritten by the incoming stored data, which causes operation problems of the mobile phone.

Furthermore, while updating the code in the memory, new code may not be stored into the second zone 13 because the size of the new code is larger than the capacity of the second zone 13 (for example, the size of the new code is 20.1 MB).

Therefore, a method and an apparatus for partitioning the memory dynamically according to the size of the code as well as for reserving a maximum capacity of the first zone are needed.

### SUMMARY OF THE INVENTION

It is an aspect of the present invention to provide a method and an apparatus for determining a boundary address of a memory according to a size of a code, such that the block storing data has a maximum space and the block storing code can accommodate the code.

The method of the present invention is applied in an electronic apparatus which has a memory being partitioned into a first zone and a second zone by an old boundary address. The first zone stores input data from users and the second zone stores a first code for operation of the electronic apparatus. The method comprises the following steps: (a) downloading a second code; (b) computing a new boundary address according to a physical space amount occupied by the second code; (c) saving the new boundary address in the memory and repartitioning the memory; and (d) overwriting the first code by the second code. Therefore, the ranges of the first zone and the second zone can be differentiated by the electronic apparatus according to the new boundary address.

While performing the step (b), the new boundary address is determined according to the physical space amount occupied by the second code and optionally a reserved space as well. In addition, step (b) further comprises a step of scanning addresses of a plurality of damaged blocks in the memory, wherein the size of the reserved space is at least equal to the size of the plurality of damage blocks.

After determining the new boundary address, the method further determines whether the new boundary address is identical with the old boundary address. If yes, the data being stored in the first zone will not be altered. If not, the method copies the data being stored in the first zone and re-writes the copied data into the first zone.

The method optionally comprises the following steps before performing the step (a): (d) providing a download apparatus configured to store the second code; and (e) connecting the download apparatus to the electronic apparatus.

The download apparatus of the present invention is configured to update a memory which is partitioned into a first zone and a second zone by an old boundary address in an electronic apparatus. The first zone stores an input data that users can input and the second zone stores a first code for operation of the electronic apparatus. The download apparatus comprises a storage unit and a transmitting port. The storage unit is configured to store a second code for overwriting the first code, and the transmitting port is configured to connect with the electronic apparatus for transmitting the second code to the electronic apparatus. The download apparatus computes a new boundary address according to a physical space amount occupied by the second code, and repartitions the memory by the new boundary address.

The electronic apparatus of the present invention repartitions a memory which is partitioned into a first zone for storing data and a second zone for storing a first code by an old boundary address. The electronic apparatus comprises an estimating unit for computing a new boundary address according to a physical space amount occupied by a second code. The memory is partitioned into a third zone and a fourth zone by the new boundary address, and the second code is stored in the fourth zone.

The estimating unit of the electronic apparatus computes the new boundary address further according to a reserved space. The electronic apparatus further comprises a scanning unit for scanning a plurality of damaged blocks in the memory, and the size of the reserved space is larger than the size of a plurality of damaged blocks.

### BRIEF DESCRIPTION OF THE DRAWINGS

FIG. 1 illustrates a partition configuration of a memory according to a prior art;

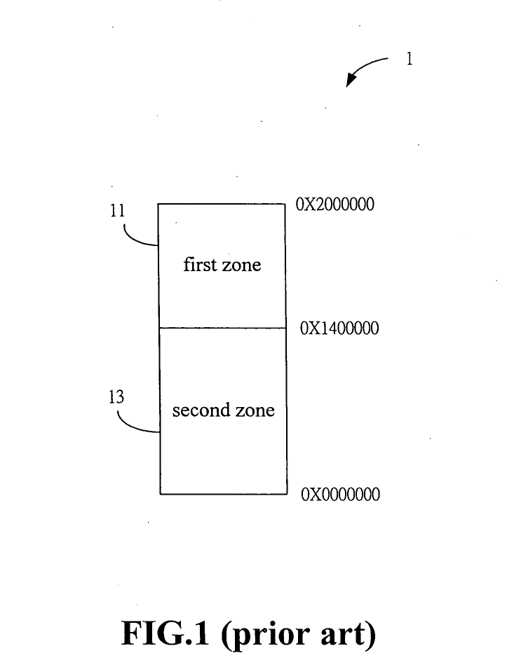

FIG. 2 illustrates the way for storing data into a first zone of FIG. 1 according to a prior art;

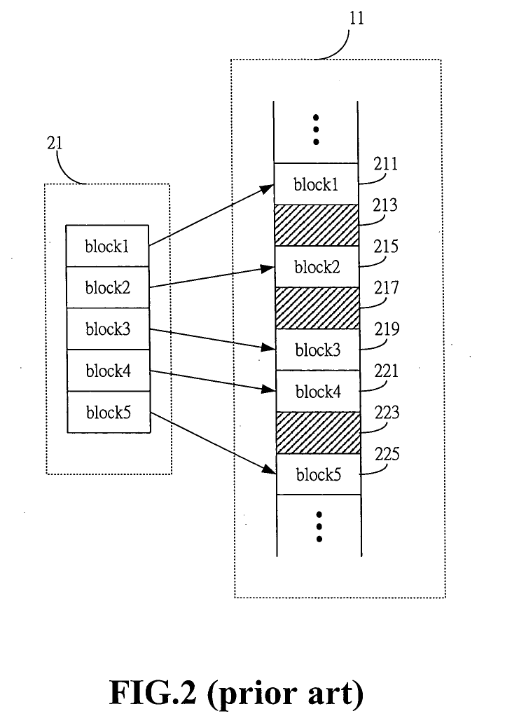

FIG. 3 illustrates a flow chart of the memory updating method according to the present invention;

FIG. 4 illustrates a hardware configuration according to an embodiment of the present invention for implementing the memory updating method;

FIG. 5 is a diagram showing how the boundary address is altered; and

FIG. 6 illustrates a hardware configuration according to another embodiment of the present invention for implementing the memory updating method.

### DETAILED DESCRIPTION

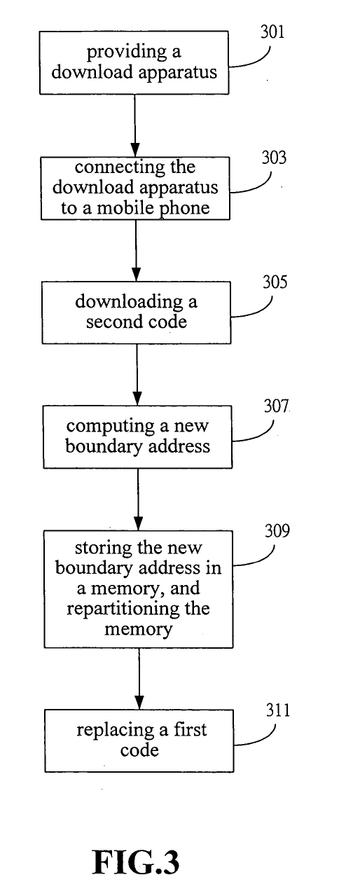

FIG. 3 is a flow chart showing a method of updating a code (first code) of a mobile phone according to the present invention, which dynamically determines a boundary address of a first zone and a second zone in a memory according to the size of the updated code (second code). For the purpose of illustration, assume that the size of the first code is 19.8 MB, the memory is a NAND gate flesh memory with 32 MB capacity, the capacity of the first zone 11 and the second zone 13 is 12 MB and 20 MB respectively before updating, and therefore the old boundary address is 0x1400000.

In the step 301, the method provides a download apparatus with a storage unit, having a size of 20.2 MB, for storing the second code used to update the first code. In the step 303, the download apparatus connects to the mobile phone by the wire connection method or infrared or other wireless transmission connection. In the step 305, the second code is downloaded to the mobile phone for updating and overwriting the first code. In the step 307, the download apparatus computes a new boundary address according to a physical space amount occupied by the second code in the second zone 13 and the size of the damaged block in the second zone 13. If the total size of the damaged blocks of the second zone 13 is 0.1 MB, the required space will be 20.2 MB+0.1 MB=20.3 MB, i.e. the new boundary address must be such that the space amount of the second zone 13 has to be equal or greater than 20.3 MB. In the step 309, the download apparatus stores the new boundary address in the memory and repartitions the memory using the new boundary address computed in the step 307. In the step 311, the download apparatus stores the second code in the second zone while overwriting the first code.

In the step 307, the new boundary address is computed not only based on the physical space amount occupied by the second code and the damaged quantity of the second zone 13, but also on an appropriate reserved space for allowing possible new findings of damaged blocks in the upcoming update operation. If the reserved space is set to 0.2 MB by the download apparatus, the practical space of the second zone 13 will be 20.3 MB+0.2 MB=20.5 MB by choosing new boundary address. Therefore, the space amount of the first zone 11 is 32 MB−20.5 MB=11.5 MB.

By the present invention, the boundary address of the memory is determined according to the practical space amount occupied by the code, such that the first zone configured to store data has a maximum space and the second zone stores the code.

The method further determines whether the new boundary address is identical with the old boundary address. If yes, the data stored in the first zone 11 needs no change. If not, the addresses of every blocks of the first zone 11 will be altered responsive to the alternation of the boundary address. Consequently, the download apparatus copies all data stored in the first zone 11 and rewrites the data into the first zone 11, and associates the updated address with the corresponding function of the mobile phone to ensure the correct access of the updated data.

In step 309, the new boundary address is stored in the second zone 13. In particular, the new boundary address is stored next to and after the block of the second code in the second zone 13.

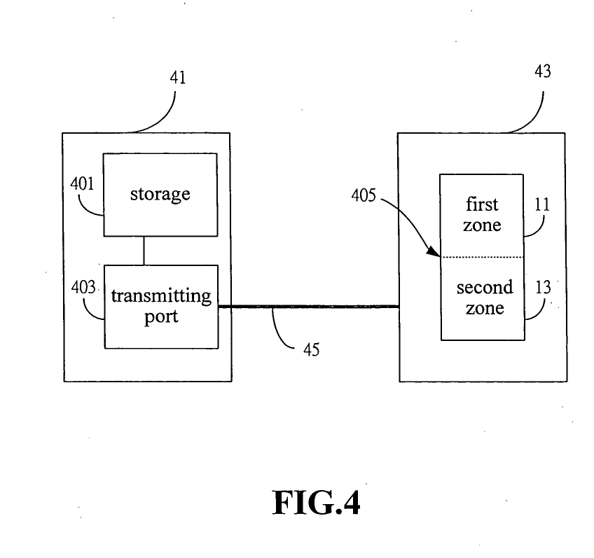

FIG. 4 illustrates a hardware configuration for the above-mentioned method, which includes a download apparatus 41 and an electronic apparatus 43. The download apparatus 41 performs the download function mentioned above, and the electronic apparatus 43 may be realized as a mobile phone. The memory of the electronic apparatus 43 is partitioned into a first zone 11 and a second zone 13 by an old boundary address. The download apparatus 41 includes a storage unit 401 and a transmitting port 403. The storage unit 401 is configured to store a second code, and the transmitting port 403 connects to the electronic apparatus 43 by a transmission line 45. As the first code needs to be updated, the download apparatus 41 downloads the second code from the storage unit 401 to the second zone 13 for overwriting the first code through the transmitting port 403 and the transmission line 45, and updates the old boundary address by a new boundary address according to the physical space amount occupied by the second code.

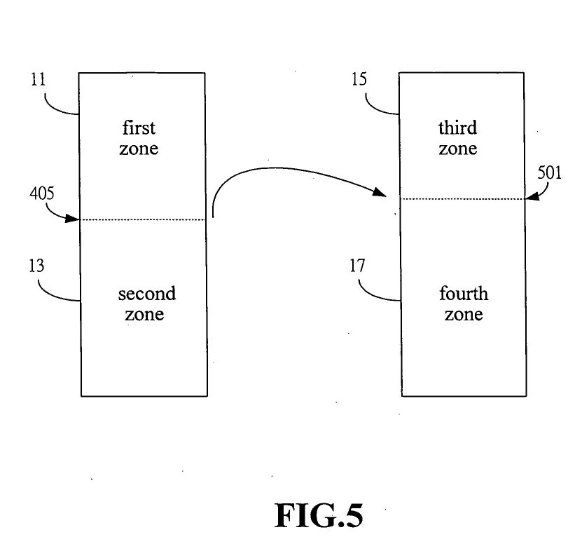

As shown in FIG. 5, if the download apparatus 41 determines that the boundary of the first zone 11 and the second zone 13 has been updated from the old boundary address 405 to the new boundary address 501, the download apparatus 41 rewrites all data of the first zone 11 into a third zone 15 (i.e. the new first zone) through the transmitting port 403 and the transmission line 45 such that the data block can be rearranged and the address of the data block corresponds to the second code. The second code is stored in the fourth zone 17 (i.e. the new second zone) as well.

The electronic apparatus 43 is rebooted after the above steps are completed, and then the electronic apparatus 43 operates according to the second code after being rebooted.

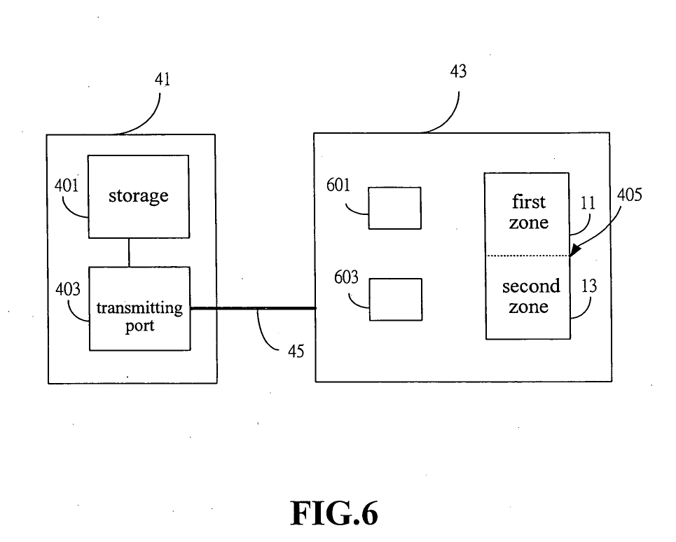

In addition to the above-mentioned embodiments, the present invention may include a download apparatus 41 and an electronic apparatus 43 as shown in FIG. 6. Different from the embodiment in FIG. 5, the electronic apparatus 43 in FIG. 6 includes an estimating unit 601 configured to compute the new boundary according to the physical space amount occupied by the second code and an appropriate reserved space. The embodiment in FIG. 6 further includes a scanning unit 630, which is configured to scan the possible damaged blocks in the memory, such that the size of the reserved space takes accounts of the size of the damaged blocks.

Although the specific embodiments of the present invention have been illustrated and described, it is to be understood that the invention is not limited to those embodiments. One skilled in the art may make various modifications without departing from the scope or spirit of the invention.

1. A method for partitioning a memory in an electronic apparatus, said electronic device comprising the memory, said memory being partitioned into a first zone and a second zone by an old boundary address, said first zone being configured to store a data, said second zone being configured to store a first code for operation of said electronic apparatus, said method comprising the following steps:
downloading a second code;
computing a new boundary address according to a physical space amount occupied by said second code;
saving said new boundary address in said memory and repartitioning said memory; and
overwriting said first code by said second code.

2. The method of claim 1, wherein said new boundary address is obtained according to said physical space amount occupied by said second code and a reserved space as performing said computing step.

3. The method of claim 2, wherein said computing step further comprises a step of scanning addresses of a plurality of damaged blocks in said memory, wherein a size of said reserved space is larger than a size of said plurality of damage blocks.

4. The method of claim 1, further comprising the following steps:
determining whether said new boundary address is identical with said old boundary address, and if not, re-writing said data into said first zone.

5. The method of claim 1, further comprising the following steps:
providing a download apparatus, wherein said second coed is stored in said download apparatus; and
connecting said download apparatus to said electronic apparatus.

6. The method of claim 1, wherein said new boundary address is stored in said second zone as performing said saving step.

7. The method of claim 1, further comprising:
partitioning said memory into a third zone and a fourth zone by said new boundary address;
storing said data in said third zone; and
storing said second code in said fourth zone.

8. The method of claim 1, wherein said memory is a NAND gate flash.

9. The method of claim 1, wherein said electronic apparatus is a mobile phone.

10. A download apparatus for updating a memory, said memory being located in an electronic apparatus and partitioned into a first zone and a second zone by an old boundary address, said first zone being configured to store a data, said second zone being configured to store a first code for operation of said electronic apparatus, said download apparatus comprising:
a storage unit configured to store a second code for overwriting said first code; and
a transmitting port configured to transmit said second code to said electronic apparatus;
wherein said download apparatus computes a new boundary address according to a physical space amount occupied by said second code, and repartitions said memory by said new boundary address.

11. The download apparatus of claim 10, wherein said download apparatus also computes said new boundary address according to a reserved space.

12. The download apparatus of claim 11, wherein a size of said reserved space is larger than a size of a plurality of damaged blocks, and said size of a plurality of damaged blocks is determined after scanning said memory by said electronic apparatus.

13. The download apparatus of claim 11, wherein said download apparatus partitions said memory into a third zone and a fourth zone by said new boundary address, and said second code is downloaded by said download apparatus and stored in said fourth zone.

14. An electronic apparatus comprising a memory, said memory being partitioned into a first zone and a second zone by an old boundary address, said first zone being configured to store a data, said second zone being configured to store a first code, said electronic apparatus comprising an estimating unit configured to compute a new boundary address according to a physical space amount occupied by a second code, said memory being partitioned into a third zone and a fourth zone by said new boundary address, and said second code being stored in said fourth zone.

15. The electronic apparatus of claim 14, wherein said estimating unit computes said new boundary address according to a reserved space.

16. The electronic apparatus of claim 15, further comprising:
a scanning unit configured to scan a plurality of damaged blocks in said memory, wherein a size of said reserved space is larger than a size of said plurality of damaged blocks.
